(19) United States
(12) Patent Application Publication
(10) Pub. No.: US 2008/0084821 A1
(43) Pub. Date: Apr. 10, 2008

(54) METHOD AND DEVICES FOR ADAPTING THE TRANSMISSION RATE OF A DATA STREAM WHEN THERE IS INTERFERENCE

(75) Inventors: Frederic Maze, Langan (FR); Eric Nassor, Thorigne Fouillard (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/866,881

(22) Filed: Oct. 3, 2007

(30) Foreign Application Priority Data
Oct. 5, 2006 (FR) 0654119

(51) Int. Cl. H04B 7/00; H04L 12/56

(52) U.S. Cl. 370/232; 370/310

(57) ABSTRACT

The object of the method and devices according to the invention is the optimization of the transmission of data packets, transmitted by several sources, in a network, when there is interference. After having received a data packet and determined its source, this data packet is analyzed in order to determine whether data packets transmitted by this source have been lost. If data packets have been lost, the type of transmission error related to the source is determined and the transmission parameters are modified according to the type of error determined. The parameters for determining the type of errors are related to the comparison of the global loss rate for data packets related to this source with the global loss rate for data packets related to all the sources.

### BACKGROUND OF THE INVENTION

The present invention concerns the transmission of data over a wireless network and more particularly a method and devices for adapting the transmission rate to a data stream in the presence of interference, when several data streams are received simultaneously by a receiver.

Wireless networks have become popular during the past few years as the technology has become mature and accessible to a large number of consumers. More and more electronic peripherals are now equipped with a wireless network interface, implementing wireless protocols such as the IEEE 802.11(a/b/g) standards. Compared with cabled networks such as for example Ethernet, wireless networks facilitate mobility, flexibility of access to communication networks and interoperability between peripherals. Although the transmission rates offered by wireless networks are generally less than those offered by cabled networks, they are however sufficient for a large number of normal uses. In addition, the transfer rates available on wireless networks are continually increasing with technological advances.

In this context, several peripherals are in a position to send simultaneously at least one compressed video stream to the same peripheral, for example a set of video cameras sending to a television receiver, using protocols adapted to the transmission of video streams such as RTP (Real-time Transport Protocol). The video stream is divided into a succession of data packets by the server peripheral. These packets are transmitted as they are generated and are played by the client peripheral as they are received (video streaming). Conventionally there exist congestion control mechanisms that best provide equitable sharing of the available bandwidth between the various video streams. One example of such a mechanism is TCP-Friendly Rate Control, or TFRC, (TCP means Transmission Control Protocol). This mechanism enables the server peripherals to estimate and share the available bandwidth without explicit interaction or synchronization between them from the observation of the variations in the outward and return time of a packet (round-frip time or RTT) and the degree of loss of the packets using an equation simulating the behavior of TCP/IP (Transmission Control Protocol/Internet Protocol) traffic under the same conditions. According to the available bandwidth thus estimated, the peripherals can implement techniques of adaptation of the video rate in order to obtain a video stream compatible with the estimated bandwidth.

One of the important particularities of a wireless network environment is that the radio waves are subject to interference either because of a modification to the environment whilst the client periphery or the server periphery moves (for example attenuation or reverberation), or because of interference coming from other peripherals transmitting in the same frequency band. For example 802.11 networks using frequencies between 2.4 and 2.4835 GHz may be disturbed by a microwave oven, Bluetooth peripherals and domestic transmitters. These intermittent interferences result in a fairly great loss of packets that may be interpreted by the congestion control mechanisms as a sign of congestion on the network. Conventionally, these mechanisms react in the presence of congestion by reducing their estimation of the available bandwidth. This estimated reduction in the bandwidth may cause a break in the display of the video stream or significant loss in display quality for the user on the destination peripheral. However, when interference is present, it is generally accepted that it is preferable to react differently, for example by reducing the size of the packets sent in order to reduce the impact of the lost packets or by implementing error correction mechanisms.

It is therefore important to be able to distinguish the types of errors and to adapt the estimation of the bandwidth so as to limit, for the user, the disturbance in display resulting from the momentary presence of interference.

Patent application WO 03/058894 describes a method for increasing the data transmission rate over a wireless network of the IEEE 802.11 type in the presence of intermittent interference caused for example by peripherals such as Bluetooth peripherals or microwave ovens in order to benefit as much as possible from conflict-free transmission periods.

The quality of the communication channel is evaluated at the network adapter, based on the packet error rate (PER) and on the signal strength. From these values, if intermittent interference is detected (by comparing the packet error rate and the signal strength with threshold values), the packet transmission rate is increased and at the same time the packet size is shortened so as to reduce the probability of packet collisions. If on the other hand the interference is judged to be constant the transmission rate is reduced. A client device not having information available on the strength of the signal received cannot use this method.

Patent application US 20020053053 describes a multimedia stream transmission apparatus that makes it possible to estimate the transmission conditions using at least the jitter information, that is to say a variation in the time separating the arrival of two successive packets, or the packet error rate, supplied by a receiving apparatus. According to the transmission conditions thus determined (the presence of congestion or interference) the sending apparatus can adapt at least one of the following transmission parameters: the data transfer rate (data bit rate) and the level of resistance of the multimedia stream to the transmission errors. This method is used on one server and consequently is not suited to the case of a client receiving several video streams from a plurality of servers since it is not possible to adapt the processing to the requirements of the client.

The article ‘End-to-End Differentiation of Congestion and Wireless Losses’, Cen, Cosman and Voelker, IEEE/ACM Transactions on Networking, Vol. 11, No. 5, October 2003, presents several methods based on heuristics for differentiating the packet losses resulting from congestion on the network from erroneous packet losses stemming from problems of transmission or interference on the wireless network. These heuristics are based on the observation of the variations in the transmission time of a packet or on the time separating the reception of two successive packets.

However, although these algorithms are a good aid for distinguishing the various types of packet loss, the complex nature of the behavior of a wireless network results in the classification error rates using these heuristics remaining very high and may thus result in an under-use of the available bandwidth.

There thus exists a need for the client peripherals receiving data streams and in particular video streams, over a wireless network, coming from several server peripherals, to optimize the transmission of the data packets. Since these transmissions may be subjected to interference, one technical problem to be resolved is the detection of the presence of interference and deciding on the distribution of the bandwidth between several servers sending data streams to the same client terminal. Such an optimization makes it possible to maintain a good quality of display of a video stream whilst avoiding risk of congestion of the other servers.

### SUMMARY OF THE INVENTION

The invention makes it possible to resolve at least one of the problems disclosed above.

Thus an object of the invention is a method for determining the type of transmission error for data packets received from a first source when data packets transmitted by the first source and by at least one second source, different from the first source, are received, this method comprising the following steps:

determining a data packet transmission error rate for each of the first and second sources;

comparing the data packet transmission error rates of the first and second sources; and,

determining the type of transmission error for data packets transmitted from the first source according to the result of the comparison of the data packet transmission error rates of the first and second sources.

Determining the type of transmission error of a data packet in a network makes it possible to characterize the state of the network and thus to take the necessary measures to optimize it.

According to a particular embodiment, the step of determining the type of transmission error for data packets transmitted from the first source according to the result of the comparison of the error rates in transmitting data packets from the first and second sources comprises the following steps:

modifying parameters of a data packet loss differentiation algorithm according to the result of the comparison of the data packet transmission error rates of the first and second sources; and,

determining the type of transmission error for data packets transmitted from the first source according to the data packet loss differentiation algorithm.

The determination of the type of error according to this embodiment is based on a data packet loss differentiation algorithm whose parameters depend on the transmission error rates of the various sources. Thus the determination of the type of error is related to an analysis of the transmission of data packets from a particular source and to the general analysis of the transmissions of data packets in the network. This dual analysis makes it possible to increase the precision in determining a type of error. Advantageously, the data packet transmission error rates are global loss rates for data packets.

According to a particular embodiment, a transmission error is of the congestion type or interference type.

Another object of the invention is a method for optimizing the reception of a plurality of data packets, the data packets of the plurality of data packets being transmitted by at least two different sources, this method comprising the following steps:

determining the type of transmission error in data packets received from at least one of the at least two different sources, referred to as the first source, according to the method described above; and,

adapting at least one data transmission or coding parameter of said first source.

According to this method, the type of error is used to optimize the transmission of data between the source, whose transmission error type has been determined, and the receiver. The invention thus makes it possible to avoid several servers encountering congestion problems whilst another server is caused to increase its transmission rate in the presence of intermittent interference.

The modified transmission or coding parameter is preferably transmitted to the first source.

According to a particular embodiment, the method of the invention also comprises the following steps:

determining the type of data stream to which the data packets received from the first source belong; and,

if the data stream is a main data stream, modifying the bandwidth allocated to the first source and to at least one other source distinct from said first source.

Still in a particular embodiment, the step of modifying the bandwidth comprises the following steps:

comparing the packet error rate of the first source, related to transmission errors of the interference type, with a predetermined threshold; and,

if the packet error rate of the first source, related to transmission errors of the interference type, is higher than the predetermined threshold, increasing the bandwidth allocated to said first source.

Preferably, the step of increasing the bandwidth allocated to the first source comprises a step of reducing the bandwidth allocated to the at least one other source, distinct from the first source. Advantageously, the method also comprises a step of canceling the modification of the bandwidth allocated to the first source and to at least one other source if the packet error rate of the first source, related to transmission errors of the interference type, is below the predetermined threshold.

According to these characteristics, the invention makes it possible in particular to provide the best quality display of the video streams coming from several servers in the presence of localized interference, according to the interest of the user.

Still according to a particular embodiment, the method also comprises a step of calculating the packet error rate of data transmitted from the first source, related to congestion errors on the network over which the data packets are transmitted, and the packet loss rate of data transmitted from the first source, related to interference errors in the network over which the data packets are transmitted. This characteristic makes it possible to maintain a representation of the state of the network and thus to optimize the transmission and coding parameters of the data packets.

Still according to a particular embodiment, the data packets are transmitted over a wireless network.

Another object of the invention is a computer program comprising instructions adapted to implement each of the steps of the method described above.

Another object of the invention is a device for determining the type of packet transmission error for data received from a first source when data packets transmitted by the first source and by at least one second source, different from the first source, are received, this device comprising the following means:

means for determining a transmission error rate for data packets for each of the first and second sources;

means for comparing the transmission error rates for data packets from the first and second sources; and,

means for determining the type of transmission error for data packets transmitted from the first source according to the result of the comparison of the transmission error rates for data packets from the first and second sources.

As indicated previously, the determination of the transmission error type for a data packet in a network makes it possible to characterize the state of the network and thus to take the necessary measures for optimizing it.

According to a particular embodiment, the means for determining the transmission error type for data packets transmitted from the first source according to the result of the comparison of the transmission error rates for data packets from the first and second sources comprise the following means:

means for modifying parameters of a data packet loss differentiation algorithm according to the result of the comparison of the transmission error rates for data packets from the first and second sources; and,

means for determining the transmission error type for data packets transmitted from the first source according to the data packet loss differentiation algorithm.

The determination of the type of error according to this embodiment is based on means using a data packet loss differentiation algorithm whose parameters depend on the transmission error rates of the various sources. Thus the determination of the type of error is related to an analysis of the transmission of data packets from a particular source and to the general analysis of the data packet transmissions in the network. These dual analysis means increase the precision of determination of the type of error.

Another object of the invention is a device for optimizing the reception of a plurality of data packets, the data packets in the plurality of data packets being transmitted by at least two different sources, this device comprising the following means:

means for determining the type of transmission error for data packets received from at least one of the at least two different sources, referred to as the first source, according to the device described previously; and,

means for adapting at least one transmission or coding parameter for the data from the first source.

Advantageously, the device also comprises means for transmitting the at least one adapted parameter to the first source.

According to this device, the type of error is used for optimizing the transmission of data between the source, where the type of transmission error has been determined, and the receiver. The invention thus makes it possible to avoid several servers encountering congestion problems whilst another server is made to increase its transmission rate in the presence of intermittent interference.

According to a particular embodiment, the device also comprises the following means:

means for determining the type of data stream to which the data packets received from the first source belong; and,

means for modifying the bandwidth allocated to the first source and to at least one other source, distinct from the first source, if the data stream is a main data stream.

Still according to a particular embodiment, the means for modifying the bandwidth comprise the following means:

means for comparing the loss rate for packets from the first source, related to transmission errors of the interference type, with a predetermined threshold; and,

means for increasing the bandwidth allocated to the first source if the loss rate for packets from the first source, related to transmission errors of the interference type, is above the predetermined threshold.

Advantageously, the means for increasing the bandwidth allocated to the source comprise means for decreasing the bandwidth allocated to the at least one other source, distinct from the first source. Preferably the device also comprises means for canceling the modification of the bandwidth allocated to the first source and to at least one other source if the packet error rate of the first source, related to transmission errors of the interference type, is below the predetermined threshold.

According to these characteristics, the device according to the invention makes it possible in particular to provide the best quality of display of the video streams coming from several servers in the presence of localized interference, according to the interest of the user.

According to a particular embodiment, the device also comprises means for calculating the error rate of data packets transmitted from the first source, related to congestion errors in the network over which the data packets are transmitted, and the loss rates for data packets transmitted from the first source, related to interference errors in the network over which the data packets are transmitted. These means make it possible to maintain a representation of the state of the network and thus to optimize the transmission and coding parameters of the data packets.

### BRIEF DESCRIPTION OF THE DRAWINGS

Other advantages, aims and characteristics of the present invention will emerge from the following detailed description, given by way non-limiting example, with regard to the accompanying drawings, in which:

FIG. 1 depicts schematically an example of an environment in which the present invention can be implemented;

FIG. 2 illustrates an example of a device adapted to implement the present invention;

FIG. 3, comprising FIGS. 3a and 3b, is an example of the screens for display and selection of a main video stream;

FIG. 4 illustrates the method of differentiating packet losses; and,

FIG. 5, comprising FIGS. 5a and 5b, depicts certain steps of an example of an algorithm for optimizing the reception of packets from several data streams, by a client peripheral, according to the present invention.

### DETAILED DESCRIPTION OF THE INVENTION

According to the invention, the solution to the problems disclosed above consist first of all, for the client peripheral, of determining that a data stream coming from a sever peripheral is disturbed by intermittent interference. For this purpose, it maintains a state of the transmission for each of the data streams coming from the various server peripherals. The state of the transmission may be related, in particular, to the variation in the time between two successive packets (jitter), to the transmission time over the network, to the size of error bursts, to their period and to the loss rate of the packets. If the client peripheral observes an increase in the losses of packets on one of the data streams received, with the other data streams behaving normally, then the client peripheral can conclude that it is not a case of a problem of congestion on the network but probably a problem of interference. The client peripheral can thus inform the server peripheral of this in order to confirm to it that it is not a question of a congestion problem. Thus there is not a risk that the server peripheral will make an error in interpretation and consequently it will be able to take suitable countermeasures to the presence of interference. Such measures are, for example, an increase in the proportion of error correction packets (FEC) and a reduction in the size of the packets sent in order to reduce the probability of data corruption. The correction measures can also relate to an adaptation of the coding parameters of the data stream. For example, in a video stream, many images are coded by differences with other images such as the images of a predictive type (P). Mention was made of time references between images. Because of these time references, the presence of an error in an image is propagated in the following images as far as the next key image of type I (type I images have no time reference). It is possible to stop the propagation of an error over several type P images by modifying the coding parameters and in particular by inserting Intra macroblocks. This technique is known by the English term “Adaptive Intra Refresh” (AIR).

In addition, if it is a case of intermittent interference, the client peripheral may decide to modify the distribution of the bandwidth between the various data flows according to the importance of the data stream to which the interference relates. If the data stream to which the data stream relates is of prime importance to the user, the client peripheral can allocate a bonus bandwidth to the server peripheral to which the intermittent interference relates so as to maintain the speed of the data stream despite the losses of packets. The client peripheral may also demand the use of additional error correction packets (FEC). The client peripheral also informs the other server peripherals of this so that they reduce their transmission speed accordingly in order to maintain the overall bandwidth in order to avoid the appearance of congestion on the network.

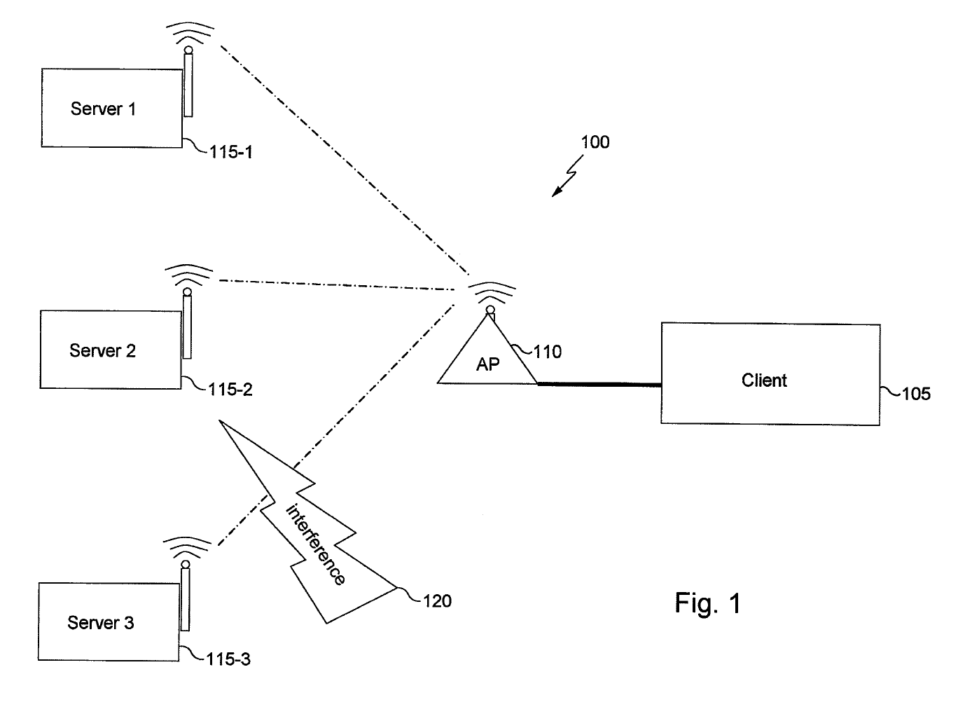

FIG. 1 illustrates schematically an example of an environment 100 in which the present invention can be implemented. According to this example, a client peripheral 105 connected to a wireless access point 110 receives several audio and/or video streams coming from server peripherals having the references 115-1, 115-2 and 115-3. The audio and/or video streams are transmitted from the sever peripherals to the access point over a wireless network, for example of the WiFi 802.11 type. The client peripheral 105 can be connected to the wireless network directly by means of a wireless interface or, as shown in FIG. 1, over a cable connection to the wireless access point 110. An example of such an implementation concerns a set of wireless network video cameras disseminated in a house, a building or any place and each broadcasting a video or audiovisual stream to the same display screen connected to a wireless access point.

The server peripherals, 115-1, 115-2 and 115-3 obtain an audio, video or audiovisual stream either from an acquisition interface, or from a storage space. The compressed audiovisual stream, for example to the MPEG2 or MPEG4 format, is divided into packets. Each packet is then transmitted to the client peripheral 105 according to a protocol adapted to the transport of data with real-time constraints such as the transfer of audiovisual data such as for example the RTP (Real-time Transport Protocol). Each packet comprises an incremental sequence number. The transport protocol is supplemented by at least one control protocol such as for example RTCP (RTP Control Protocol) in order to control the transmission of the data, to monitor the quality of the service and to allow the exchange of control information between the various participants.

In addition, the server peripherals 115-1, 115-2 et 115-3 implement packet stream control techniques compatible with the congestion control mechanisms of the TCP/IP protocol. These techniques are used by the server peripherals in order to adapt their packet transmission rate so as to ensure naturally an equitable sharing of the bandwidth between the various data streams. The TFRC protocol is an example of a packet stream control technique known to the one skilled in the art.

FIG. 1 also depicts the presence of intermittent interference 120 influencing a sub-assembly of the server peripherals, here the server 115-3. This interference may result in the loss of corrupted packets at the client peripheral. This interference may also result in an increase in the transmission time and the jitter between the server peripheral 115-3 and the client peripheral 105 because of re-transmissions of lost packets. It may be a case of disturbances related to the moving of the server peripheral or the presence of other sources of radio waves transmitting in the same frequency band 2.4 to 2.4835 GHz such as microwave ovens, Bluetooth peripherals and domestic transmitters. The other peripheral servers 115-1 and 115-2 are not influenced, or only a little influenced, by this interference 120 since they are sufficiently far away or protected from the source of this interference.

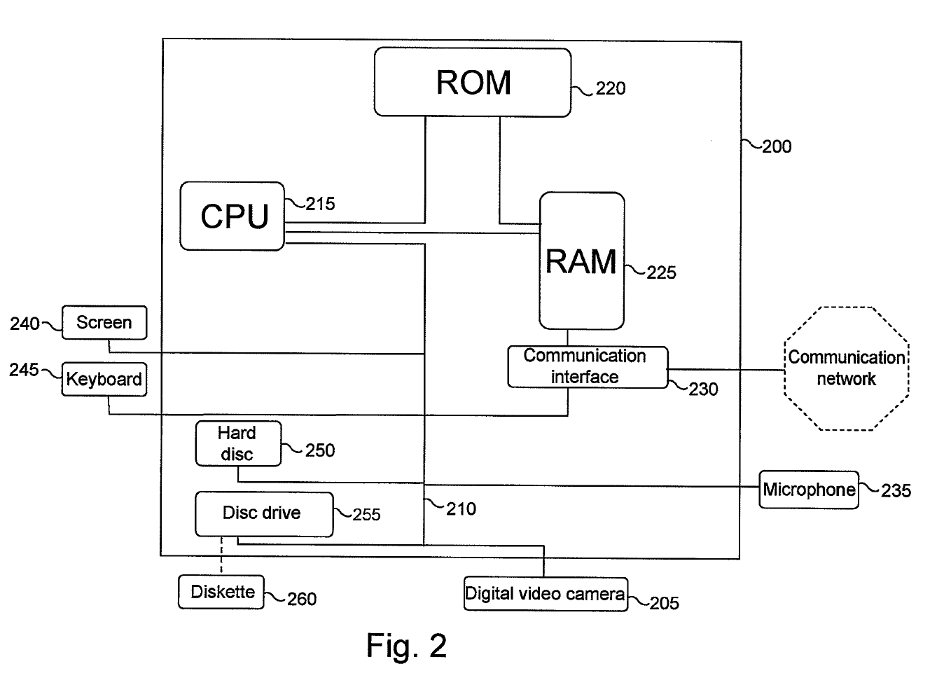

FIG. 2 illustrates an example of an apparatus 200 adapted to implement the invention. The apparatus 200 can be used as a client peripheral or as a server peripheral in the environment presented in FIG. 1. The apparatus 200 is for example a microcomputer, a workstation, a personal assistant, a mobile telephone or more generally any peripheral, mobile or not, capable of being connected, directly or not, to a wireless communication network. This apparatus can be connected to various peripherals such as for example a digital video camera 205, a scanner or any other image acquisition or storage means connected to an input/output card (not shown) and supplying multimedia data to the apparatus 200. The apparatus 200 can also be a photographic apparatus, a television or a camcorder, provided with a communication interface enabling it to be connected to a wireless network.

The apparatus 200 comprises a communication bus 210 to which there are preferably connected:

a central processing unit 215 such as a microprocessor, denoted CPU (Central Processing Unit);

a read only memory 220 able to contain programs for implementing the invention, denoted ROM (Read Only Memory);

a random access memory 225, which, after powering up, contains the executable code of the method according to the invention as well as registers adapted to record variables and parameters necessary for implementing the invention, denoted RAM (Random Access Memory); and,

a communication interface 230 connected to the communication network, the interface being able to transmit and receive data.

Optionally the apparatus 200 can also have the following components:

an input/output card (not shown) connected to a microphone 235, used in particular for transmitting an audio stream;

a screen 240 for displaying data and/or serving as a graphical interface with the user, who will be able to interact with the programs according to the invention, by means of a keyboard 245 supplemented or not by any other means such as a pointing device, such as for example a mouse, an optical pen or a touch screen;

a hard disk 250 or a storage memory such as a flash compact card, able to contain the programs according to the invention and data used or produced during the implementation of the invention; and,

a disk drive 255 (or for any other removable data medium) adapted to receive a diskette 260 and to read or write thereon data processed or to be processed according to the invention.

The communication bus affords communication and interoperability between the various elements included in the apparatus 200 or connected to it. The representation of the bus is not limiting and in particular the central unit is able to communicate instructions to any element of the apparatus 200 directly or by means of another element of the apparatus 200.

The diskettes 260 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method according to the invention to be implemented.

The executable code enabling the apparatus to implement the invention may be stored either in read only memory 220, on the hard disk 250 or on a removable digital medium such as for example a diskette 260 as described previously. According to a variant, the executable code of the programs can be received by means of the communication network, via the interface 230, in order to be stored in one of the storage means of the apparatus 200 before being executed, such as the hard disk 250.

The central unit 215 is adapted to control and direct the execution of the instructions or portions of software code of the program or programs according to the invention, instructions that are stored in one of the aforementioned storage means. On powering up, the program or programs that are stored in a non-volatile memory, for example on the hard disk 250 or in the read only memory 220, are transferred into the random access memory 225, which then contains the executable code of the program or programs according to the invention, as well as registers for storing the variables and parameters necessary for implementing the invention.

It should be noted that the apparatus comprising the device according to the invention can also be a programmed apparatus. This apparatus then contains the code of the computer program or programs, for example fixed in an application specific integrated circuit (Application Specific Integrated Circuit or ASIC).

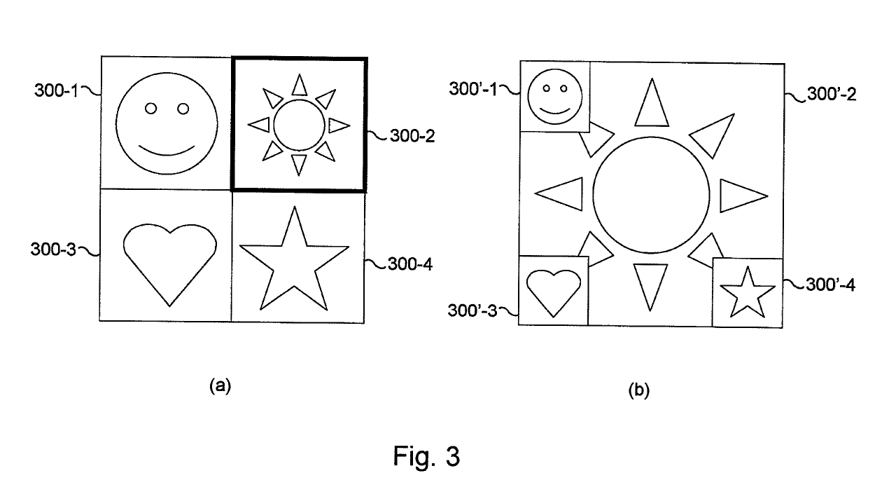

The client peripheral receives several data streams, for example several video streams to be displayed. FIG. 3, comprising FIGS. 3a and 3b, presents examples of display of a video stream on a screen and of distinction between a main stream and secondary streams. As illustrated in FIG. 3a, the video streams can be displayed in the form of a mosaic of images comprising four video display zones referenced 300-1 to 300-4. The main video screen can be selected by the user by means for example of a remote control by moving a cursor on the screen, represented by the black square in FIG. 3a. In this example, the video stream corresponding to the display zone 300-2 is selected. The user can thus select a main video stream in order for example to display it in full screen. In general terms a main data stream refers to a data stream whose transmission is higher than the others (by reason for example of images to be displayed that are larger or of a higher sampling frequency) or to a data stream having higher quality constraints than for the secondary streams, that is to say, for example, a data stream whose error rate must be low.

In the example in FIG. 3b, the main stream is displayed in full screen in the display zone 300′-2, the secondary streams being displayed in the form of thumbnail images, superimposed, in the display areas 300′-1, 300′-3 and 300′-4.

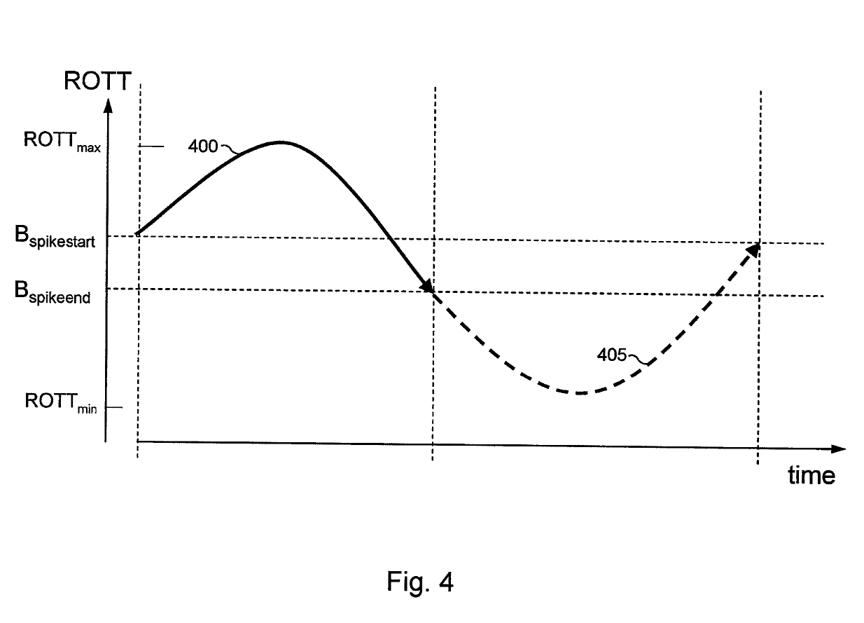

FIG. 4 shows an example of change in the transfer time of a packet and illustrates the general principle of a packet loss differentiation algorithm known by the name ‘spike’. FIG. 4 and the ‘spike’ algorithm are given by way of illustration (the invention can use any other packet loss differentiation algorithm). According to this algorithm, the transfer time of a network packet (Relative One-way Trip Times or ROTT) is used to determine the various types of error. The ROTT is the measurement of the time taken by a packet to go from the transmitter to the receiver. Thus the measurement of the ROTT of the packet received makes it possible to determine the various types of error. If the value of the ROTT is close to the minimum transfer time of a packet measured on the connection (ROTTmin), it can be deduced that the network is not congested and that the loss of a packet is therefore due to a network error that may be related to interference. If on the other hand the value of the ROTT is appreciably greater than the value of ROTTmin, the loss of a packet is probably due to congestion on the network.

A state is associated with each data stream. A data stream enters a so called ‘spike’ state if

the data stream was not in the ‘spike’ state previously, and

the ROTT of the data stream exceeds a threshold Bspikestart.

In a similar manner a stream leaves a ‘spike’ state if

the data stream was previously in the ‘spike’ state, and,

the ROTT of the data stream drops below a threshold Bspikeend.

The thresholds Bspikestart and Bspikeend are defined according to the following equations:

Bₛₚᵢₖₑₛₜₐᵣₜ=ROTTₘᵢₙ+α(ROTTₘₐₓ−ROTTₘᵢₙ)

B_{spikeend}=ROTTₘᵢₙ+β(ROTTₘₐₓ−ROTTₘᵢₙ)

where ROTTmax is the maximum time observed for the transfer of a packet, ROTTmin is the minimum time observed for the transfer of a packet and α and β are adjustable parameters with α≧β. The values α=½ and β=⅓ are known to give, on average, good results. Conventionally, the two values α and β are fixed.

The arrow in a continuous line (400) in FIG. 4 characterizes a ‘spike’ state of the data stream whilst the arrow in a broken line (405) characterizes a non-spike’ state. If a packet loss occurs at the time when the data stream is in the ‘spike’ state, it is considered that the loss was caused by congestion, otherwise it is considered that it is a case of a network error. A ‘spike’ state, therefore corresponds to an environment in which the transmission errors are related to a congestion of the network whilst the non-‘spike’ state corresponds to an environment in which the transmission errors are related to the transmission per se.

In a variant, the outward and return time of a packet (Round-Trip Time or RTT) between the transmitter and the receiver can be used instead of the ROTT.

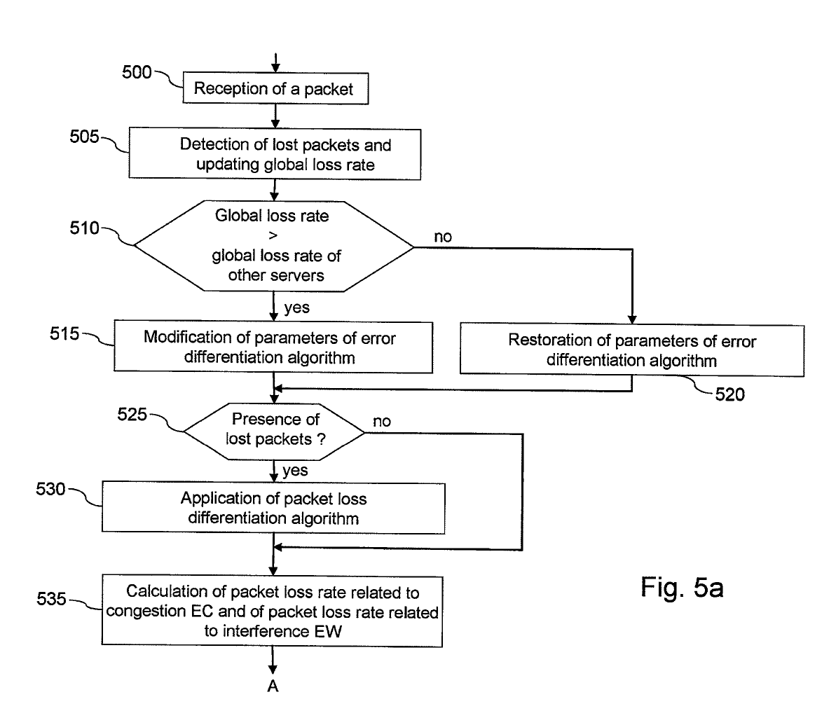

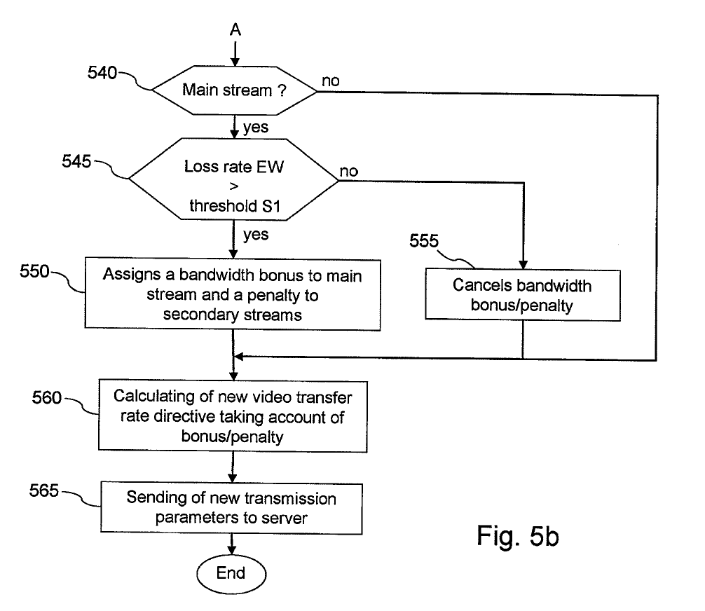

FIG. 5, comprising FIGS. 5a and 6b, depicts certain steps of an example of an algorithm for optimizing the reception of RTP packets of several data streams, by a client peripheral, according to the present invention. According to the first step illustrated, the client peripheral receives a new packet RTP coming from a server peripheral (step 500). In a second step, the client peripheral determines whether packets have been lost (step 505). Each RTP packet contains a sequence number that is incremented by the server peripheral for each packet sent. On reception of a packet, the client peripheral compares the sequence number of the packet received with that of the packet expected, that is to say with the last packet number received, incremented by one, of the corresponding data stream. If the client peripheral receives a packet whose sequence number is higher than the sequence number expected, at least one packet is considered to be lost. In order to be more robust when there is resequencing of packets (packets reordering), the client peripheral can await the reception of a few packets with a sequence number higher than the sequence number expected before considering a packet to be lost. The client peripheral keeps up to date a global packet loss rate for each of the incoming data streams, using a conventional method such as that presented in the document “RTP: A Transport Protocol for Real-Time Applications”, IETF, RFC 3550, January 1996. The proportion of packets lost can be obtained, for example, by dividing the number of packets received by the number of packets expected since the sending of the control information packet RTCP RR (Receiver Report).

In a following step, the client peripheral compares the global loss level of the current stream with the global loss levels observed for the data streams coming from the other server peripherals (step 510). If the global loss level is clearly greater than that of the other data streams, it is highly probable that a greater part of the losses observed are related to network interferences rather than to congestion of the network. The client peripheral can use, for example, the following relationship in order to determine whether the current global loss level (Loss_level) is greater than that of the other data streams:

$$\frac{Loss\_level - \overline{Loss\_level}}{\overline{Loss\_level}} > ρ$$

where Loss_level is the average of the global loss levels for all the data streams and ρ is a predetermined threshold.

The current global loss level is considered to be higher than that of the other data streams if the threshold ρ is passed, for example beyond 20%.

In variant, the client can in a similar manner compare the value of the jitter associated with each of the data streams.

If the global loss level is considered to be higher than that of the other data streams, the client modifies the parameters of the error differentiation algorithm in order to favor the detection of errors related to network errors (step 515), this is to say in particular errors related to interference. In the case of the spike algorithm presented above, the client peripheral modifies the parameters α and β so as to raise the Bspikestart and Bspikeend thresholds. He can for example fix α=⅔ and β=½.

If the global loss level is not considered to be higher than that of the other data streams, the client peripheral restores the default parameters of the error differentiation time algorithm (step 520).

In a following step, the client peripheral determines whether packets have been detected as being lost during step 505 (step 525). If packets have been detected as being lost, the client peripheral uses the error differentiation algorithm described previously in order to characterize the losses observed as losses related to congestion of the network or alternatively as losses related to network errors (step 530).

In a following step, the client peripheral updates a distinct loss rate for the congestion errors, denoted EC, and for the network errors, denoted EW (step 535). If it is determined at step 530 that the data stream is suffering network congestion, all the losses at step 505 are included in the calculation of the network congestion loss rate. Conversely, if it is determined at step 530 that the data stream is suffering transmission problems such as interference, all the losses identified at step 505 are included in the calculation of the network transmission loss rates. The loss rates are preferably updated on reception of each new packet in order to take account of the packets received and the packets lost.

After having determined the packet loss rates EC and EW, the client peripheral determines the nature of the current data stream in order to determine whether it corresponds to the main data stream (step 540). The main stream is the one to which the interest of the user relates, it is a question of the stream from which it is desirable to maintain the best display quality. If the current data stream is the main data stream, the level of losses related to network errors (EW) is compared with a threshold S1 (step 545). The threshold S1 is preferably relatively low. The threshold S1 enables the client peripheral to determine the method of allocation of bandwidth to the current data stream.

In accordance with the first method of allocating bandwidth to the current data stream, applied when there is interference on the network (EW>S1), the client peripheral decides to grant a bonus bandwidth to the main stream that is subject to interference (step 550). This bonus can consist of a percentage (for example 10%) of the bandwidth calculated by the equation according to the TFRC. This bonus bandwidth enables the server peripheral to make its data stream more robust to interference by sending supplementary error correction packets (FEC) and/or by reducing the size of the packets without having to reduce the quality and transmission speed of the data stream. In order to avoid causing congestion on the network in allowing this supplementary bonus, the client peripheral also assigns to the other server peripherals a penalty in the form of a bandwidth to be deducted from that which is already allocated, calculated, for example, according to the TFRC equation. The bandwidth bonus allocated to the main data stream is thus equitably distributed over all the other data streams in the form of a penalty.

According to a second method of allocating bandwidth to the current data stream, corresponding to the normal operating mode (EW<S1), the client peripheral returns to default functioning and eliminates all the bandwidth bonuses/penalties assigned to the data streams received by the client peripheral (step 555).

In a following step, the client peripheral calculates the new bandwidth directive for the current data stream using, for example, the TFRC equation from the RTT and the congestion loss rates EC, to which there is added or subtracted the bonus/penalty assigned to the current data stream (step 560).

If at step 540 the current data stream is not the main data stream, the client peripheral directly calculates the new bandwidth directive as described at step 560.

At step 565, the client peripheral sends to the server peripheral of the current data stream an information message (feedback) in the form of an RTCP packet containing at least the new bandwidth directive and the packet loss rates EC and EW. This information enables the server peripheral to adapt to the size of the packets transmitted, the proportion between the data packets and the error correction packets (FEC), and the data stream transmission rate (and the quality for audiovisual streams).

In a variant, in accordance with a variant of TFRC, step 560 is executed by each of the server peripherals. The client peripheral then determines the bonus/penalty level to be allocated to each of the server peripherals, in accordance with the invention, and communicates the bonus/penalty levels to the server peripherals in addition to the information necessary for the TFRC equation (RTT, congestion loss rates EC) for the calculation of the new bandwidth directive.

For each data stream received, the client peripheral keeps up to date the parameters for calculating its error state. By way of example, these parameters can be as follows:

| | |
|---|---|
| ROTT | Transfer time for a packet between the transmitter and |
| | receiver |
| ROTTmin | Minimum transfer time measured for a packet between the |
| | transmitter and receiver |
| ROTTmax | Maximum transfer time measured for a packet between the |
| | transmitter and receiver |
| ‘Spike’ state | Value 0 if the data stream is not in a ‘spike’ state, value 1 if |
| | the data stream is in a spike' state |
| α | Current value of parameter α. |
| β | Current value of parameter β. |
| Last No | Last number of the packet received from the data stream |
| of packet | |
| received | |
| E | Global packet loss rate |
| EC | Packet loss rate related to network congestion |
| EW | Packet loss rate related to transmission |
| Main | Value 0 if the data stream is not the main stream, |
| | value 1 if the data stream is the main stream |
| Bonus/ | Supplementary bandwidth percentage allocated or deducted |
| Penalty | with respect to the allocated bandwidth |
| Bandwidth | Allocated bandwidth increased or decreased according to |
| | the bonus/penalty. |

Naturally, in order to satisfy specific requirements, a competent person in the field of the invention will be able to apply modifications in the above description.

1. A method for determining the type of transmission error for data packets received from a first source when data packets transmitted by the first source and by at least one second source, different from the first source, are received, the method comprising the following steps:
determining a data packet transmission error rate for each of said first and second sources;
comparing said data packet transmission error rates of said first and second sources; and
determining the type of transmission error for data packets transmitted from said first source according to the result of said comparison of said data packet transmission error rates of said first and second sources.

2. The method according to claim 1, wherein said step of determining the type of transmission error for data packets transmitted from the first source according to the result of said comparison of said error rates in transmitting data packets from said first and second sources comprises the following steps:
modifying parameters of a data packet loss differentiation algorithm according to the result of said comparison of the data packet transmission error rates of said first and second sources; and
determining the type of transmission error for data packets transmitted from the first source according to the data packet loss differentiation algorithm.

3. The method according to claim 1, wherein said data packet transmission error rates are global data packet loss rates.

4. The method according to claim 1, wherein a transmission error is of the congestion type or of the interference type.

5. A method for optimizing the reception of a plurality of data packets, the data packets in said plurality of data packets being transmitted by at least two different sources, the method comprising the following steps:
determining the type of transmission error for data packets received from at least one of said at least two different sources, referred to as the first source, according to claim 1; and
adapting at least one data transmission or coding parameter of said first source.

6. The method according to claim 5, further comprising a step of transmitting said at least one adapted parameter to said first source.

7. The method according to claim 1, further comprising the following steps,
determining the type of data stream to which the data packets received from said first source belong; and
if said data stream is a main data stream, modifying the bandwidth allocated to said first source and to at least one other source, distinct from said first source.

8. The method according to claim 7, wherein said step of modifying the bandwidth comprises the following steps:
comparing the packet error rate of the first source, related to transmission errors of the interference type, with a predetermined threshold; and
if the packet error rate of the first source, related to transmission errors of the interference type, is higher than the predetermined threshold, increasing the bandwidth allocated to said first source.

9. The method according to claim 8, wherein said step of increasing the bandwidth allocated to said first source comprises a step of reducing the bandwidth allocated to said at least one other source, distinct from said first source.

10. The method according to claim 7, further comprising the step of canceling the modification of the bandwidth allocated to said first source and to at least one other source if said packet loss rate of said first source, related to transmission errors of the interference type, is less than said predetermined threshold.

11. The method according to claim 5, further comprising a step of calculating the loss rate for data packets transmitted from said first source related to congestion errors on the network over which the data packets are transmitted, and the loss rate for data packets transmitted from said first source related to interference errors in the network over which the data packets are transmitted.

12. The method according to claim 1, wherein the data packets are transmitted over a wireless network.

13. A computer-readable storage medium on which is stored a computer readable adapted to implement each of the steps of the method according to claim 1.

14. A device for determining the type of packet transmission error for data received from a first source when data packets transmitted by the first source and by at least one second source, different from the first source, are received, the device comprising:
first determining means for determining a transmission error rate for data packets for each of said first and second sources;
comparing means for comparing said transmission error rates for data packets from said first and second sources; and
second determining means for determining the type of transmission error for data packets transmitted from said first source according to the result of the comparison of said transmission error rates for data packets from said first and second sources.

15. The device according to claim 14, wherein said second determining means for determining the transmission error type for data packets transmitted from the first source according to the result of the comparison of said transmission error rates for data packets from said first and second sources further comprises:
modifying means for modifying parameters of a data packet loss differentiation algorithm according to the result of the comparison of said transmission error rates for data packets from said first and second sources; and
third determining means for determining the transmission error type for data packets transmitted from said first source according to said data packet loss differentiation algorithm.

16. A device for optimizing the reception of a plurality of data packets, the data packets in said plurality of data packets being transmitted by at least two different sources, the device comprising:
means for determining the type of transmission error for data packets received from at least one of said at least two different sources, referred to as the first source, according to the device of claim 14; and
adapting means for adapting at least one data transmission or coding parameter of said first source.

17. The device according to claim 16, further comprising transmitting means for transmitting said at least one adapted parameter to said first source.

18. The device according to claim 16, further comprising:
third determining means for determining the type of data stream to which the data packets received from the first source belong; and
modifying means for modifying the bandwidth allocated to the first source and to at least one other source, distinct from the first source, if the data stream is a main data stream.

19. The device according to claim 18, wherein said modifying means for modifying the bandwidth comprises:
second comparing means for comparing the loss rate for packets from the first source, related to transmission errors of the interference type, with a predetermined threshold; and
increasing means for increasing the bandwidth allocated to the first source if the loss rate for packets from the first source, related to transmission errors of the interference type, is above the predetermined threshold.

20. The device according to claim 19, wherein said increasing means for increasing the bandwidth allocated to said first source comprises decreasing means for decreasing the bandwidth allocated to said at least one other source, distinct from said first source.

21. The device according to claim 18, further comprising canceling means for canceling the modification of the bandwidth allocated to said first source and to at least one other source if said packet loss rate of said first source, related to transmission errors of the interference type, is less than said predetermined threshold.

22. The device according to claim 16, further comprising calculating means for calculating the loss rate for data packets transmitted from said first source, related to congestion errors on the network over which the data packets are transmitted, and the loss rate for data packets transmitted from said first source, related to interference errors in the network over which the data packets are transmitted.
